(19) United States
(12) Patent Application Publication
(10) Pub. No.: US 2022/0170220 A1
(43) Pub. Date: Jun. 2, 2022

(54) Method for the Installation of an Offshore Wind Turbine Tower

(71) Applicant: ESTEYCO S.A., Madrid (ES)

(72) Inventors: Jose Salustiano SERNA GARCIA-CONDE, Madrid (ES); Carlos GARCIA ACON, Madrid (ES)

(21) Appl. No.: 17/601,259

(22) PCT Filed: Apr. 3, 2020
(86) PCT No.: PCT/ES2020/070224

§ 371 Date: Oct. 4, 2021

(30) Foreign Application Priority Data
Apr. 5, 2019 (ES) P2019 30315

(51) Int. Cl. E02B 17/02; F03D 13/20; F03D 13/25; E02D 27/42

(52) U.S. Cl. CPC E02B 17/02; F03D 13/22; E04H 12/342; E02D 27/425; F03D 13/25

(57) ABSTRACT

The invention relates to a method for the installation of a marine (or in general, aquatic) wind-powered generator tower, wherein said tower advantageously comprises a foundation that is open at the top and equipped with a substantially flat lower slab and a perimeter wall. The method includes, in the different stages thereof, the depositing or removal of ballast material in or from the main cavity of the foundation, and wherein in the absence of said ballast material, the wind-powered generator or the foundation is a floating or self-floating structure. The method is particularly suitable for the installation of wind-powered generators in areas of low depth (or near-shore areas), preferably of less than 15 m.

### FIELD OF THE INVENTION

The present invention relates to a method for the installation of an offshore wind-powered generator tower, wherein said tower preferably comprises a foundation with a substantially flat lower slab. The technical field of application of the invention therefore relates to the area of renewable energies, and more specifically techniques for the installation of offshore generation structures (or, in general, offshore in any other aquatic environment). The invention is particularly suited in wind farms that are close to the coast or in low depth areas, commonly known as near-shore.

### BACKGROUND OF THE INVENTION

Methods for the installation of offshore wind-powered generator towers in marine environments of moderate or high depths (high depths understood to be greater than 15 meters), such as the one described in patent application WO0134977A, for example, are known today. In said method, there are arranged a metal or concrete foundation the interior of which is leak-tight, and a wind-powered generator tower on the mentioned foundation. The buoyancy of the wind-powered generator assembly is adjustable by means of pumps which allow depositing or removing a volume of water in/from the inner cavity of said foundation and/or of the tower. This allows, in different phases of the process, the foundation to be provisionally moored (increasing its ballast volume) in order to install the turbine on the tower, and subsequently, said ballast is drained with pumps, setting the assembly afloat again. Under this condition, a transport vessel can be integrally coupled to the tower and travel to the final offshore installation point. For said installation, water is pumped back into the foundation, which causes the assembly to sink until reaching the seabed.

Although methods of this type allow the buoyancy of the tower assembly to be adjusted in an efficient manner during the different stages of mounting the turbine and installing same at depths of greater than 15 meters, they present serious limitations when they are applied to near-shore operations, as a consequence of the complexity of their foundation and ballast systems. This is because the construction of one leak-tight foundation (required for high depths) requires large amounts of material so as to assure that said foundation is leak-tight, which generally makes it necessary to install an upper slab covering the ballast intake cavities. The corresponding higher weight implies depths which make it impossible to transfer and install the foundation in areas with little depth, thereby limiting the applicability of solutions in near-shore cases. The use of intake systems, valves, pumps, etc. in technologies of this type likewise complicates installation processes both on an operative level and due to the higher risk of a breakdown involved during the stages of ballasting and unballasting the foundation or the tower. This causes installation technologies of this type to be rather unsuitable for offshore or near-shore wind farms with a large number of towers.

Furthermore, in relation to techniques for ballasting offshore tower foundations, foundations based on open compartments (also known as cells), such as those of the foundation described in patent ES2593263B1, are also known. Said foundation is a self-transporting concrete gravity-based structure, which can be moored without the need for auxiliary elements (such as vessels, buoys, etc.). Nevertheless, the foundation involves considerable complexity, and a ring-shaped horizontal slab is required, adding excessive constructive stages to the process for manufacturing same. Again, this added complexity and weight cause foundations of this type to be unsuitable for offshore wind farms with a large number of towers, or for near-shore installation regions. Furthermore, the process for ballasting same is not reversible, or at least not without using complex techniques.

Finally, in relation to the specific techniques for transporting the mentioned foundations, are known transport systems based on vessels equipped with hoisting or mooring jacks, such as the transport craft described in patent ES2607428B1, for example. Said craft consists of a U-shaped floating structure and a plurality of hoisting jacks arranged as means for lifting or for the downward movement of the foundation or of the tower.

Nevertheless, the specific use of said transport vessels in near-port or near-shore operations applied to near-shore wind farms has not been disclosed in the state of the art until now.

In light of the aforementioned technical problems and limitations, it has accordingly become necessary to provide new methods for the near-shore (that is, preferably at depths of less than 15 meters) installation of wind-powered marine generator towers, which allow the stages of mounting the wind-powered generator on the tower, as well as the stages relating to the transport of the assembly formed by the tower and the wind-powered generator to its final offshore mooring point to be performed in a more efficient manner.

The present invention allows said need to be met as a result of a novel method for the installation of a wind-powered marine generator tower and a wind-powered generator obtained by means of said method.

### BRIEF DESCRIPTION OF THE INVENTION

To solve the drawbacks of the state of the art described above, the object of the present invention is to provide a method for the installation of wind-powered generators that is particularly suitable for areas of low depth, or near-shore areas.

Said object of the invention is preferably carried out by means of a method for the installation of an offshore wind-powered generator of the type comprising a wind turbine and a tower shaft, wherein the wind-powered generator is likewise equipped with a foundation comprising a lower slab and a perimeter wall arranged on said lower slab, such that said foundation acts as a supporting base of the wind-powered generator on the seabed, and wherein the inner enclosure demarcated by the lower slab and the perimeter wall forms a main cavity that is open at the top, with said foundation being suitable for the intake of ballast material, and wherein in the absence of said ballast material, the wind-powered generator or its foundation is a floating or self-floating structure.

Advantageously, the method comprises carrying out the following stages:
a) building the foundation in dry condition;
b) putting said foundation afloat;
c) transporting said foundation, in a floating or self-floating manner, to the vicinity of a pier;
d1) depositing ballast material in the main cavity of the foundation;
d2) before or after step d1), increasing the depth of the foundation until it is supported in supporting terrain on the seabed, in a mounting position in the vicinity of said pier wherein, when the foundation is supported on said terrain, the upper level of the perimeter wall remains above the water level, without the water overflowing at the top from outside the foundation into its main cavity;
e) mounting on the foundation at least part of the shaft of the tower and the wind-powered generator, using for that purpose a crane arranged on the pier;
f) while the foundation remains supported in the mounting position on the supporting terrain, coupling the foundation to an auxiliary floating system, such that said foundation and said auxiliary floating system become substantially integral with one another at least in terms of heave, roll, and pitch, the assembly of said foundation and said auxiliary floating system forming a transport unit, wherein the auxiliary floating system comprises:
   vertical connection means adapted for vertically connecting the foundation and the auxiliary floating system and allowing vertical forces to be transmitted between both;
   upward movement/downward movement means adapted for varying in a controlled manner the vertical level or position of the foundation;
g) applying, through the upward movement/downward movement means, an upward vertical force on said foundation and a downward vertical force on said auxiliary floating system, such that at least part of the weight of the foundation and/or the wind-powered generator is suspended from said auxiliary floating system;
h) removing ballast material from the main cavity of the foundation;
i) putting the transport unit afloat;
j) transporting the transport unit in a floating or self-floating manner until being positioned over a final installation point on the seabed;
k) supporting the foundation on the seabed, on the final installation point, performing for that purpose the following steps in any order or simultaneously:
   k1) depositing ballast material in the main cavity of the foundation;
   k2) acting on the upward movement/downward movement means so as to reduce in a controlled manner the height or level of the foundation, until it is supported on the seabed at the installation point, maintaining at all times a positive freeboard of the auxiliary floating system;
l) decoupling the auxiliary floating system from the foundation, performing for that purpose one or more of the following steps:
   I1) acting on the upward movement/downward movement means to reduce and/or cancel out the vertical forces supported by the vertical connection means;
   I2) disconnecting the vertical connection means from the foundation;
m) transporting the auxiliary floating system for recovery and/or reuse.

In a preferred embodiment of the invention, the foundation of the wind-powered generator comprises one or more of the following elements:
a lower pedestal for supporting the tower shaft;
a plurality of supporting props or struts for supporting the tower shaft or connected to a pedestal of the foundation itself;
one or more separating partitions arranged inside the main cavity of the foundation.

In another preferred embodiment of the invention:
the lower slab and/or the perimeter wall are leak-tight, or
the lower slab and/or the perimeter wall comprise auxiliary intake points for taking in ballast material, optionally equipped with filling valves.

In another preferred embodiment of the invention, during step k2), the water level surpasses the upper level of the perimeter wall with at least half of the volume of the main cavity of the foundation occupied by ballast material deposited during step k1).

In another preferred embodiment of the invention, in step k1), the entry of ballast material into the main cavity of the foundation is allowed through one or more auxiliary intake points for taking in said ballast material arranged in the lower slab and/or in the perimeter wall until the ballast material occupies at least half of the volume of the main cavity of the foundation.

In another preferred embodiment of the invention, during step k2), the auxiliary floating system supports the weight of the foundation with a positive freeboard, with the main cavity of the foundation being completely filled with ballast material.

In another preferred embodiment of the invention, in the transport unit, the auxiliary floating system presents a freeboard greater than the freeboard of the perimeter wall of the foundation.

In another preferred embodiment of the invention the method comprises, after stage i), one or more of the following stages:
n) filling at least part of the main cavity of the foundation with solid ballast material, provided through the upper opening of said foundation;
o) protecting any of the elements of the wind-powered generator with one or more anti-washout means.

In another preferred embodiment of the invention, the method comprises:
before stage c), stage:
p) assembling the foundation in a dry dock area, wherein said dry dock area presents a water intake sluice gate configured for adjusting the degree of flooding of the dry dock, and during stage b), opening said sluice gate to flood the dry dock area, keeping the upper level of the perimeter wall of the foundation above the water level, such that the water does not flow over the top from outside the foundation into its main cavity; and/or
after stage e) and before stage j), stage:
q) performing one or more start-up and/or performance monitoring operations of the wind-powered generator.

In another preferred embodiment of the invention, in stage d) and/or step k1) of the method, the filling of the main cavity of the foundation with ballast material is performed with water and/or by gravity.

In another preferred embodiment of the invention, the foundation comprises one or more side protrusions and a pre-stressing system adapted for applying a pre-stressing force for pressing the auxiliary floating system against said side protrusions of the foundation. The side protrusions are preferably a prolongation of the lower slab beyond the outer face of the perimeter wall of the foundation. The advantage of this configuration is that by pressing the foundation against the auxiliary floating system, relative side movements between both are limited. In order to favor said horizontal coupling, the contact surfaces between said protrusions and the auxiliary floating system can comprise friction enhancing means, or gear-like elements or projections on one surface which fit in the other surface. Additionally, by pre-stressing, the variations in force received by the cables of the upward movement/downward movement means during transport in particular are reduced, and the fatigue thereof (the fatigue of the cables and of the lifting means themselves) is thereby reduced.

In another preferred embodiment of the invention, the upward movement/downward movement means comprise:
at least three lifting cranes or jacks arranged in the auxiliary floating system, comprising suspension cables the lower end of which are connected to the foundation;
and wherein in step k2), the foundation moves downwards by adjusting the length of said suspension cables, such that the relative level between the foundation and the auxiliary floating system varies as the foundation progressively moves downwards until reaching the bottom;
adjustable floating means, adapted for modifying the degree of sinking of the foundation and/or of the transport unit.

In another preferred embodiment of the invention, the upward movement/downward movement means comprise:
a fixed connection between the auxiliary floating system and the foundation, which does not allow the relative level between both elements to vary. Said connection can preferably be done by means of horizontal pins coming out of the auxiliary floating system and penetrating a hole of the perimeter wall, such that said floating system and the foundation are coupled to and uncoupled from one another by removing or inserting those pins;
a ballast system in the floating system which allows the ballast to be adjusted in the hull thereof;
and wherein in step k2) the foundation moves downwards by adjusting the ballast in the auxiliary floating system in order to increase the depth of the assembly such that the auxiliary floating system and the foundation move downwards together without varying their relative level until the foundation is supported on the bottom,
and wherein the auxiliary floating system has a height sufficient for being able to be immersed together with the foundation, maintaining at all times a positive freeboard. In sites of considerable depth, this can optionally be achieved by means of posts protruding from the deck of the auxiliary floating system, in such a way that the deck thereof can be immersed, but the posts continue to protrude. The area of the posts in that case must be sufficient so as to provide sufficient stability to the assembly when the deck of the floating system has been immersed.

In another preferred embodiment of the invention, during step k2) of the method, the auxiliary floating system remains in substantially the same position with respect to the water level.

In another preferred embodiment of the invention, the auxiliary floating system presents a ring structure which completely surrounds the foundation and is articulated so that it can open and close so as to be coupled to and uncoupled from the foundation. By completely surrounding the foundation, the effective freeboard thereof can be increased, thereby preventing the risk of the inlet of water, particularly during transport.

In another preferred embodiment of the invention, the auxiliary floating system presents a water plane area and a freeboard such that during step k2), the auxiliary floating system can support the weight of the wind-powered generator and the foundation partially immersed and with the main enclosure completely filled with ballast, maintaining a positive freeboard.

In another preferred embodiment of the invention, the final installation point on the seabed presents a depth of less than 15 m.

In a second aspect, the present invention relates to a wind-powered generator installed by means of a method according to any of the embodiments described herein.

The aforementioned embodiments must not be understood as being limiting of the scope of protection of the invention, where said scope comprises any technically possible combination of said embodiments, provided that they are not mutually exclusive. Furthermore, even though this document generally relates to the installation of wind-powered generators in the marine environment, the invention must be understood as also being applicable or in reference to any other type of aquatic environment.

The expression “substantially” applied to any of the terms used herein shall be understood as being identical to or comprised in a range varying by 10%, up or down.

### DESCRIPTION OF THE DRAWINGS

The preceding and other features and advantages will be better understood from the detailed description of the invention, as well as from the examples of the preferred embodiment relating to the attached drawings, in which:

FIG. 1 shows a general profile view of a wind-powered marine generator, suitable for the installation thereof by means of the method of the invention.

FIGS. 2a-2b show, respectively, a profile view and a plan view of the foundation of the wind-powered generator of the invention, in a preferred embodiment thereof.

FIG. 3 shows a stage of manufacturing the foundation of the wind-powered generator in a dry dock, with the help of a crane adapted for that purpose.

FIG. 4a shows a stage of manufacturing a plurality of foundations of a wind-powered generator according to the present invention, arranged in a dry dock area, in different degrees of execution of the mounting thereof. FIG. 4b shows a stage after flooding the dry dock.

FIG. 5 shows a stage of installing the wind turbine of the wind-powered generator on the tower shaft and the foundation, according to a preferred embodiment of the invention.

FIG. 6 shows a perspective view of the transport unit formed by the foundation of the wind-powered generator and the auxiliary floating system.

FIGS. 7a-7c show two possible embodiments of U-shaped (7a) or ring-shaped (7b-7c) vessel-type auxiliary floating system.

FIGS. 8a-8d show different stages of mooring the wind-powered generator at its final installation point, being supported on the auxiliary floating system during said mooring.

FIGS. 9a-9b show a stage of filling the main cavity of the foundation with a granular ballast material likewise covered with a layer of rocks.

### LIST OF REFERENCE NUMBERS IN THE FIGURES

| | |
|---|---|
| (1) | Wind-powered generator |
| (1′) | Wind turbine |
| (1″) | Tower shaft |
| (2) | Foundation |
| (2′) | Pedestal of the foundation |
| (3) | Lower slab of the foundation |
| (4) | Perimeter wall of the foundation |
| (5) | Seabed/aquatic bed |
| (6) | Main cavity of the foundation |
| (7) | Ballast material |
| (8, 8′) | Auxiliary intake points for taking in ballast |
| (9) | Supporting struts/props |
| (10) | Separating partitions |
| (11) | Supporting terrain of the foundation |
| (12) | Dry dock |
| (13) | Crane |
| (14) | Water intake sluice gate |
| (15) | Water level |
| (16) | Pier |
| (17) | Auxiliary floating system |
| (18) | Transport unit |
| (19) | Vertical connection means |
| (20) | Upward movement/downward movement means |
| (21) | Final installation point |

### DETAILED DESCRIPTION OF THE INVENTION

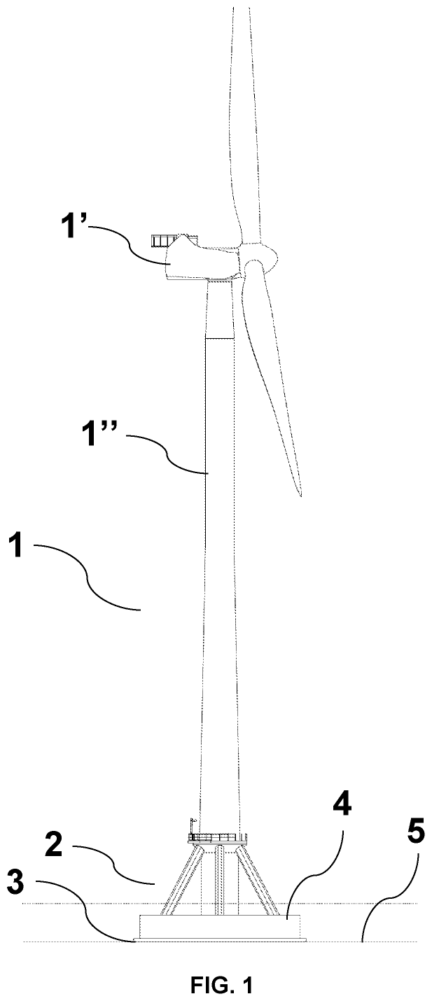

A detailed description of the invention in reference to different preferred embodiments thereof, based on FIGS. 1-9 herein, is set forth below. Said description is provided for illustrative purposes, but not for limiting the claimed invention.

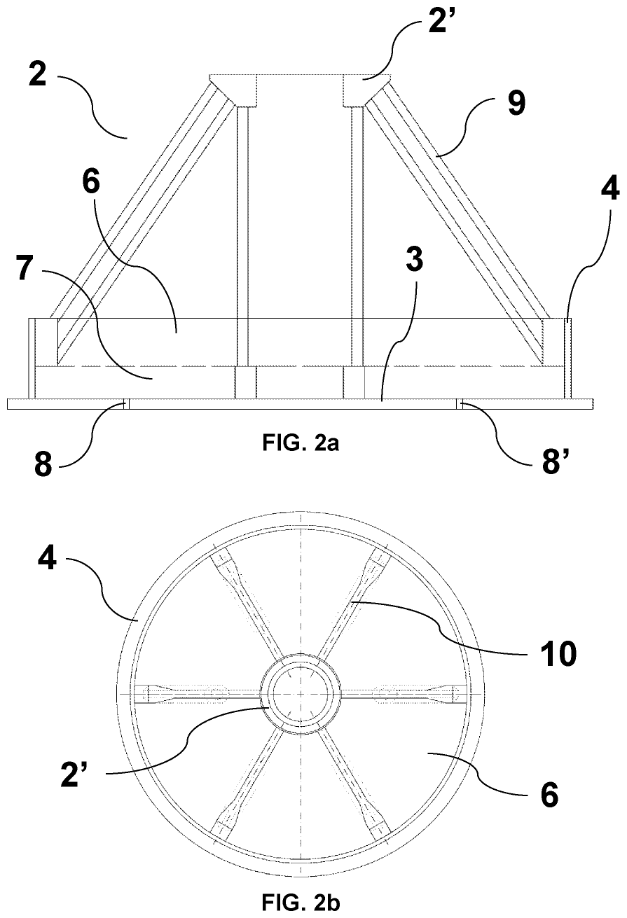

FIG. 1 shows a general profile view of a wind-powered marine generator (1) suitable for the installation thereof by means of the method of the invention. Said wind-powered generator (1) preferably comprises a wind turbine (1′) at its upper end and a tower shaft (1″) in its central region. Likewise, at its lower end, the wind-powered generator (1) presents a foundation (2) in turn comprising a preferably leak-tight lower slab (3) with a substantially horizontal shape, and an also preferably leak-tight perimeter wall (4) arranged on the lower slab (3), such that said foundation (2) acts as a supporting base of the wind-powered generator (1) on the seabed (5) (or generally aquatic bed). Likewise, and as shown in FIGS. 2a-2b (which respectively depict profile and plan views of the foundation (2)), the inner enclosure demarcated by the lower slab (3) and the perimeter wall (4) forms a main intake cavity (6) for taking in ballast (7), configured for housing a volume of material (whether water, sand, gravel, etc.) which modifies the buoyancy of the assembly so as to facilitate the operations for mooring the wind-powered generator (1) until reaching the seabed (5). Nevertheless, in the absence of a ballast (7) in the main cavity (6) of the foundation (2), said wind-powered generator is preferably self-floating.

Unlike other foundations in the state of the art, and as seen in FIGS. 2a-2b, the main cavity (6) of the foundation of the invention is a cavity that is partially or completely open in the upper region, adapted for taking in or removing ballast (7) in different stages of the method for installation and/or transport of the wind-powered generator (1). Likewise, in other embodiments of the invention, it is also possible to arrange one or more auxiliary points (8, 8′) for the inlet or inlet of ballast (7) in other regions of the foundation. Said points (8, 8′) for inlet/outlet will preferably be used as water accesses to the main cavity (6) of the foundation (1), intended for the mooring thereof. More preferably, said accesses will be regulated by valves or similar passage control means.

In addition to the aforementioned elements, the foundation (2) of the wind-powered generator (1) of the invention preferably comprises a plurality of supporting struts (9) or props for supporting the tower shaft (1″) or connected to a lower pedestal (2′) of the foundation (2) itself, intended for reinforcing the structure of the assembly. Additionally, in different embodiments of the invention (see FIG. 2b), the main cavity (6) of the foundation (2) can present one or more separating partitions (10), intended for reinforcing its structural integrity, with a preferably radial arrangement.

As mentioned in the section relating to the background of the invention, the wind-powered generator (1) herein described is particularly intended for the installation thereof in aquatic or marine environments of low depth, preferably at depths of the seabed (5) of less than 15 meters. For that purpose, it is essential for the assembly formed by the turbine (1′), shaft (1″), and foundation (2) to be lightweight compared with other offshore wind-powered generators intended for the installation thereof at greater depths (greater than 15 meters). In this sense and as will be described in detail below, the use of a foundation (2) that is open at the top is fundamental, such that the total mass is less, and the depth of the floating assembly is always kept at acceptable limits above the seabed/aquatic bed (5) in the stages of assembly, transport, or installation in which the wind-powered generator (1) is afloat.

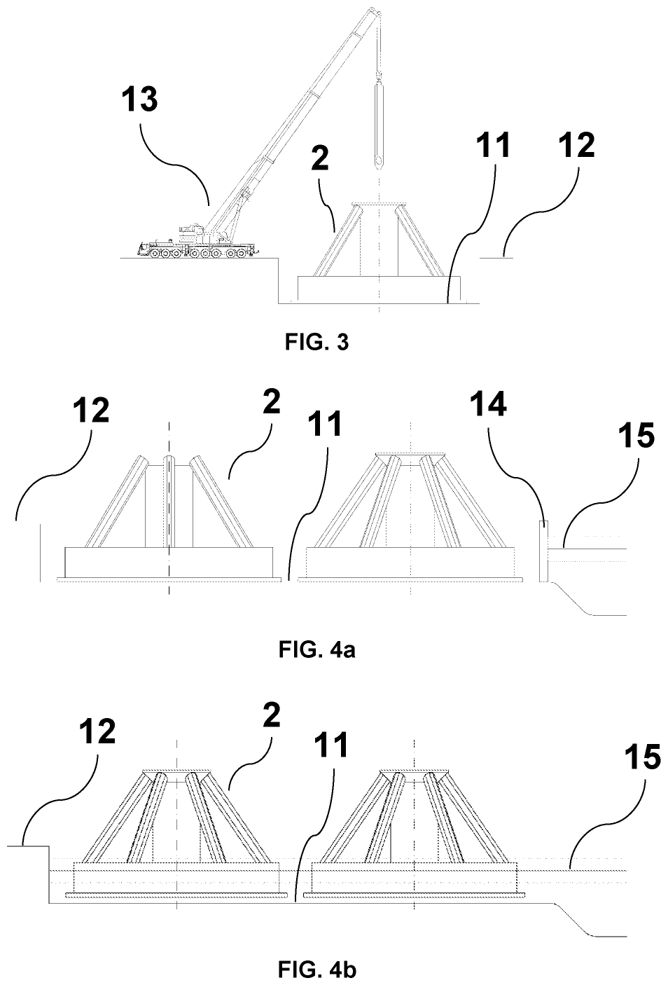

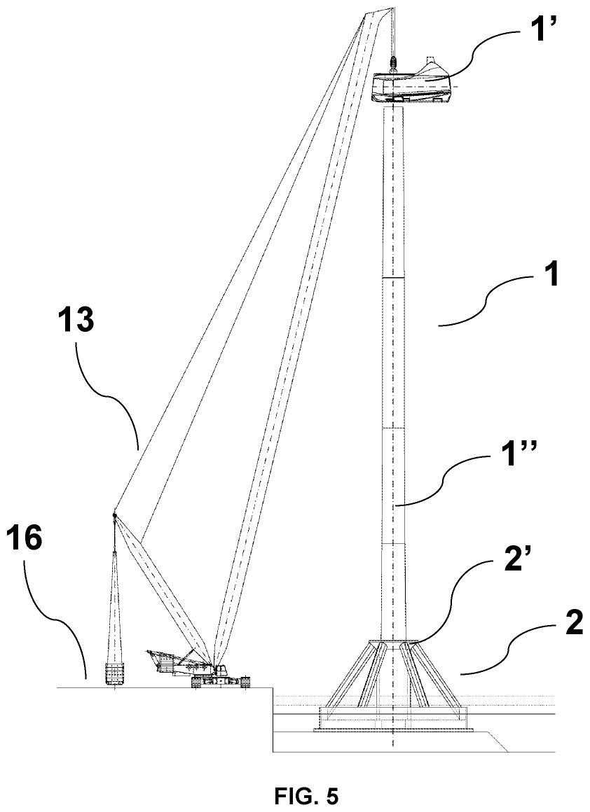

Initially, the installation of the wind-powered generator presents a phase of manufacturing the foundation (2), which is performed preferably under dry condition, with its lower slab (3) supported on the terrain (11). Said foundation will more preferably be a foundation made entirely or partially of concrete, by means of the techniques conventionally used in processes of manufacturing structures with this material. FIGS. 3 and 4 herein show different stages of this phase, in which it can be seen how the foundation (2) is assembled in a dry dock area (12), with the help of a crane (13) adapted for that purpose (FIG. 3). As mentioned, the specific method for assembling the elements of the foundation (2) is not an essential part of the invention, so any techniques known in the state of the art can be used. Likewise, FIG. 4a shows a plurality of foundations (2) according to the present invention, arranged in a dry dock area in different degrees of execution of the mounting thereof. Preferably, the dry dock area (12) presents a sluice gate (14), or similar water intake means intended for adjusting the degree of flooding of the dry dock (12). Once the foundation (2) is completed, the sluice gate (14) is opened, leaving water to progressively flood the dock (12), until the thrust produced by the volume of incoming water itself sets the foundation (2) afloat (FIG. 4b). Essentially, during the operation of setting the foundation (2) afloat, the upper level of its perimeter wall (4) remains above the water level (15), thereby assuring that water does not flow over the top from outside the foundation (2) into its main cavity (6).

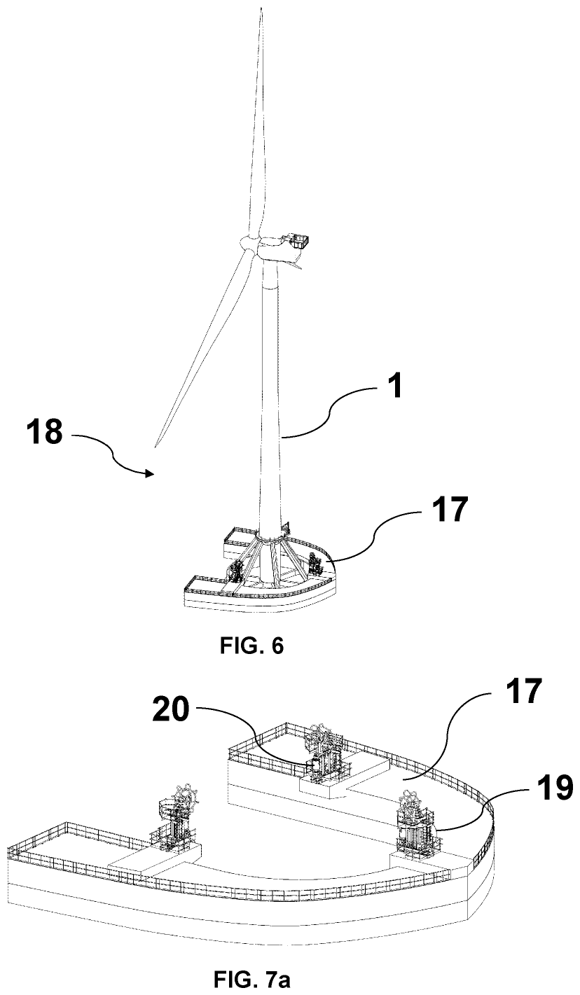

Once the foundation (2) is entirely assembled and afloat (after the controlled flooding of the working dry dock (12), as described above), it can be transported or towed by water, in a floating or self-floating manner (i.e., either because it floats with the help of an auxiliary floating element, or else because the wind-powered generator (1) is capable of floating by itself), to a second area in the vicinity of a pier (16) (FIG. 5). At that that point, and for the purpose of assembling the remaining elements of the wind-powered generator (1) (that is, the shaft (1″) and the turbine (1′)) on the foundation (2), it is necessary to support said foundation (2) on the bottom (5) again. For that purpose, ballast material (7) (preferably, water) will be deposited in the main cavity (6) of the foundation (2), for example by means of filling said cavity (6) with hydraulic pumps or similar means, or by means of opening auxiliary filling points (8, 8′), in the event that they are used. Durante this stage, the main cavity (6) of the foundation (2) will be flooded progressively and in a controlled manner, until said foundation is supported on the bottom (5), maintaining the stability and horizontal alignment of the assembly. Alternatively, tide variations can be utilized to moor the foundation (2). Likewise, and in an essential manner in the approach of the present invention, during this mooring phase in the second area close to the pier (16), the upper level of the perimeter wall (4) again remains above the water level (15), thereby assuring that when the mooring supporting the foundation (2) on the bottom (5) is completed, the water does not flow over the top from outside the foundation (2) into its main cavity (6). Nevertheless, in moments after said mooring, it is possible for the water to surpass the perimeter wall (4) and be deposited in the main cavity (6) (for example, due to tide variations, or for any other reason). It is important to clarify that said filling with water after mooring the foundation (2) does not involve any risk for the stability thereof, given that at that time it is already supported on the bottom (5).

After the completion of the mooring of the foundation (2) in the second area close to the pier (16), the mentioned remaining elements of the wind-powered generator (1) will be installed, as shown in FIG. 5. This will therefore comprise the mounting of the tower shaft (1″) on the foundation (2) (preferably, on its pedestal (2′)) and, subsequently, the installation of the wind turbine (including its blades) as the final step of this phase. Preferably, the installation of these elements is performed with the help of a crane (13) and similar auxiliary equipment. The specific method for mounting the shaft (1″) and the turbine (1′) is not, in and of itself, an essential part of the present invention, where any methods or tools known in the state of the art can be used for that purpose.

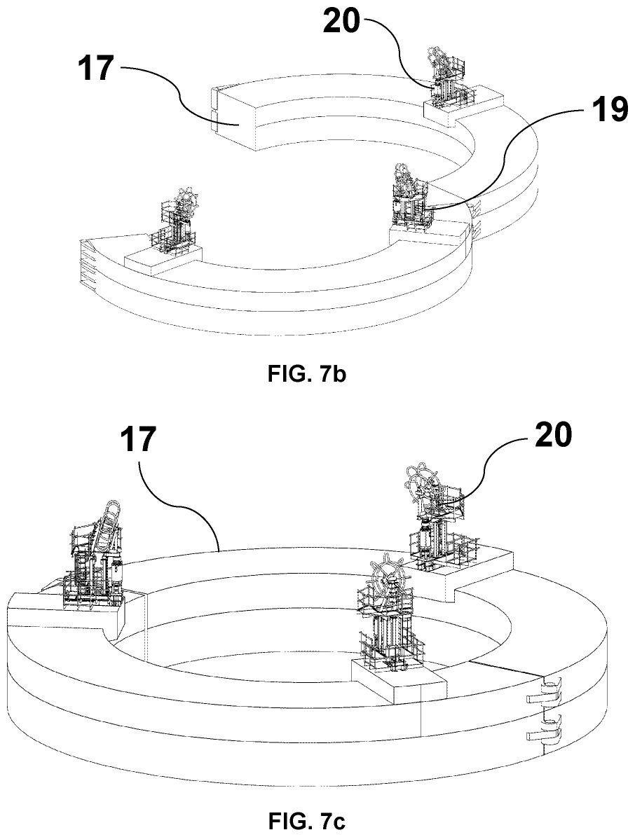

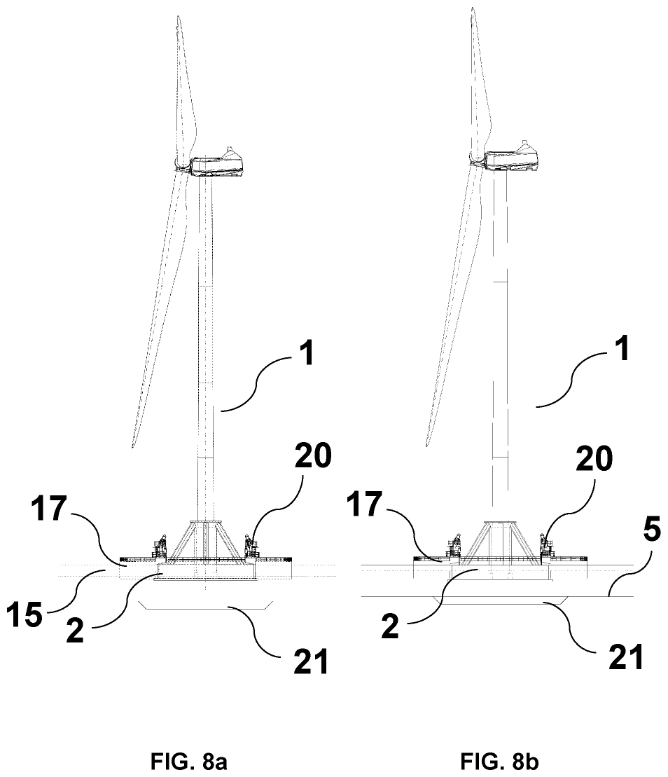

After completely mounting the wind-powered generator (1) as described in the preceding paragraph, and while the foundation (2) is still supported in the mentioned mounting position on the bottom (5), an auxiliary floating system (17) will be coupled to the foundation (2), such that said foundation (2) and said auxiliary floating system (17) present a movement integral with one another at least in terms of heave, roll, and pitch, the assembly of the foundation (2) and the auxiliary floating system (17) forming a transport unit (18) (FIG. 6 herein shows a perspective view of said transport unit (18)). Likewise, the auxiliary floating system (17) preferably comprises one or more vertical connection means (19), which can vertically connect said foundation (2) and said auxiliary floating system (17) and allow vertical forces to be transmitted between both. Preferably, the vertical connection means (19) comprise a plurality of cables which are extended from the floating system (17) to the foundation (2), when the latter is supported on the bottom (5). Likewise, any other known vertical connection means can also be used in the scope of the invention. More preferably, the vertical connection means (19) are connected at points regularly distributed across the foundation (2). In addition to the vertical connection means (19), the floating system (17) also comprises one or more upward movement or downward movement means (20), which allow varying in a controlled manner the vertical level or position of the foundation (2). Preferably, said upward movement/downward movement means (20) comprise cranes, hydraulic lifting jacks, or similar devices selected from those known in the state of the art. Other tools such as auxiliary floating elements (buoys or similar systems) which can be coupled to the foundation (2) can also be considered upward movement/downward movement means (20) in the scope of the invention. FIGS. 7a and 7b-7c show two possible embodiments of a U-shaped (FIG. 7a) or ring-shaped (FIGS. 7b-7c) vessel-type auxiliary floating system (17). Nevertheless, another type of systems or vessels that are self-driven or not, as well as another type of specific forms thereof, are likewise possible as auxiliary floating systems (17) in the scope of the invention, with the specific embodiment thereof therefore not being an essential element thereof.

The phase for the integral configuration of the auxiliary floating system (17) and foundation (2) which gives rise to the transport unit (18) is preferably carried out as follows: first, the vertical connection means (19) are applied to the foundation (2), which is supported on the bottom (5). Secondly, and upward vertical force is applied on the foundation (2) by the upward movement/downward movement means (20) of the auxiliary floating system (17), maintaining the stability of said foundation (2) by means of the control of the position thereof, through the vertical connection means (19). Said force is applied until the upper level of the perimeter wall (4) of the foundation (2) is again located above the water level (15), subsequently being maintained until the final mooring of the wind-powered generator (1) at its place of operation.

Likewise, and once the upper level of the perimeter wall (4) of the foundation (2) is located above the water level (15), ballast (7) is removed from inside the main cavity of the foundation (2), for example by means of hydraulic pumps, this emptying thereby contributing to the buoyancy of the assembly forming the transport unit (18) (preferably, the removal of ballast (7) will be performed until the foundation (2) is completely emptied, although without any limitation to any other type of scenarios in which a partial emptying is performed). At this point, the relative position of the foundation (2) and of the auxiliary floating system (17) is fixed through the vertical connection means (19), being integral with one another at least in terms of heave, roll, and pitch, maintaining the transport unit (18) afloat.

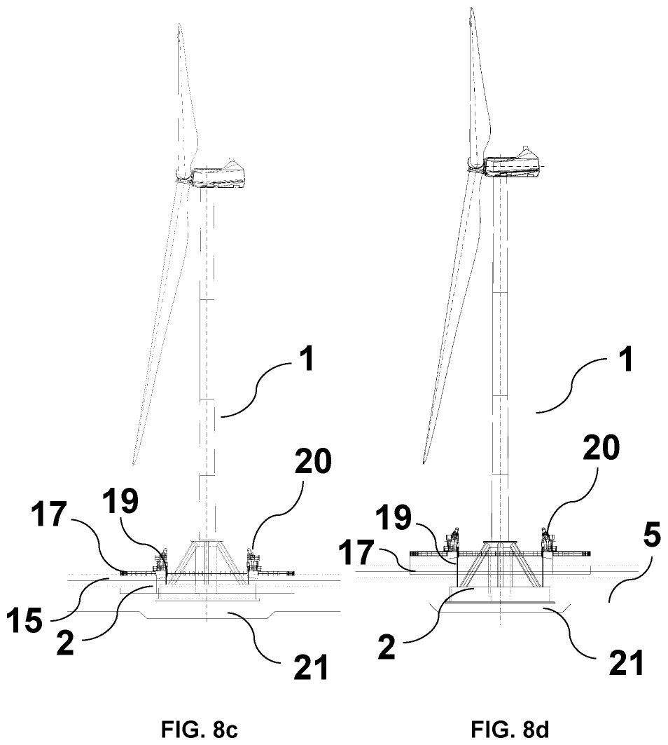

After completing the integral configuration of the transport unit (18) as described in the preceding paragraph, said unit (18) will be towed or transported by water, in a floating or self-floating manner, until being positioned over its final installation point (21) on the seabed/aquatic bed (5) (this situation is illustrated in FIG. 8a herein). The transport can be performed both by self-driven means (for example, said means being included in the auxiliary floating system (17)), and by means of tows. Once the final installation point (21) has been reached, the foundation (2) and the auxiliary floating system (17) will be integrally uncoupled again in the transport unit (18) and final mooring of the foundation (2) on the seabed/aquatic bed (5) will be performed.

To perform the mentioned mooring, the following steps are carried out in any order or simultaneously: in a first step, illustrated by FIG. 8b, the main cavity (6) of the foundation (2) is filled with ballast material (7) using pumps for that purpose or by controlling the opening of the water intake points (8, 8′), flooding the foundation (2) in its immersed region. With this, the filling of said foundation (2) occurs in a stable manner for the assembly of the wind-powered generator (1). Likewise, in a second step, the upward movement/downward movement means (20) of the auxiliary floating system (17) are operated to reduce in a controlled manner the height or level of the foundation (2) (FIG. 8c), until it is supported on the seabed/aquatic bed (5), maintaining at all times a positive freeboard of said auxiliary floating system (17) (FIG. 8d). At this point, the assembly of the wind-powered generator (1) will be supported on the bottom (5), in its final installation point (21).

In the final stage of the method for the installation of the wind-powered generator (1), in a preferred embodiment of the invention, the auxiliary floating system (17) of the foundation (2) is definitively uncoupled, performing for that purpose one or more of the following steps: in a first step, the upward movement/downward movement means (20) of the auxiliary floating system (17) are acted on to reduce and/or cancel out the vertical forces supported by the vertical connection means (19). In a second step, said vertical connection means (19) are disconnected from the foundation (2). And in a third step, the auxiliary floating system (17) is towed for recovery and/or reuse in other installation operations (for example, to install multiple wind-powered generators (1) in one and the same offshore wind farm).

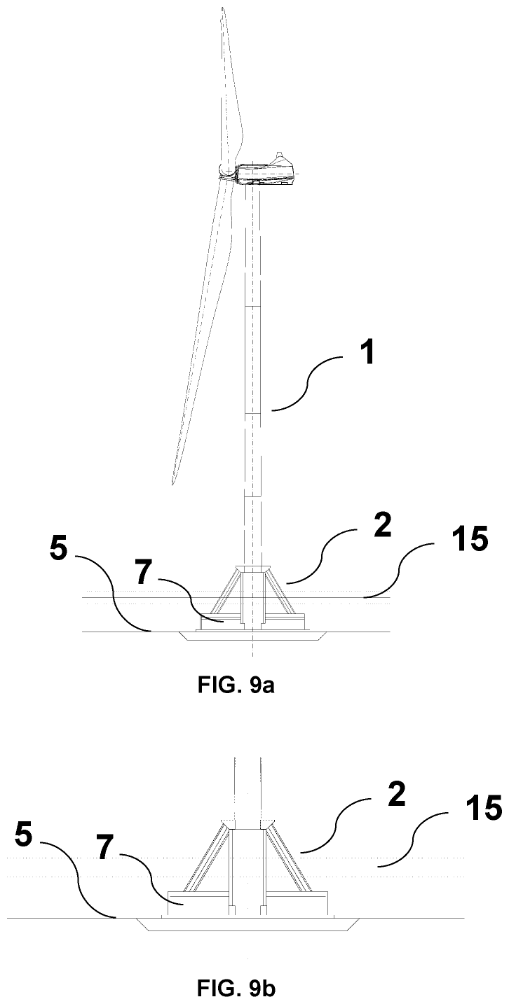

Once the wind-powered generator (1) is supported on the bottom (5), before or after the definitive uncoupling of the auxiliary floating system (17), it is possible to perform additional operations for ballasting the main cavity (6) of the foundation (2), as shown by way of example in FIGS. 9a-9b herein. It can be seen in said figures how said main cavity (6) is filled with a granular ballast material (7) (for example, sand or gravel) occupying most of the volume demarcated by said cavity (6). Likewise, to prevent said ballast (7) from leaving the foundation (2) due to erosion, washout, or displacement of the surrounding water mass, the granular material can be covered with a surface layer of rocks, like an upper protection. In different embodiments of the invention, it is also possible to fill the tower shaft (1″) of the wind-powered generator with water and/or with solid ballast, at least up to the level of the water level (15).

Finally, the foundation (2) or any other immersed part of the wind-powered generator (1) can also be protected with anti-washout elements such as rock, sand, seeds, tires, or other similar protection elements.

1. A method of installing an offshore wind-powered generator, of the type comprising a wind turbine and a tower shaft, wherein the wind-powered generator is likewise equipped with a foundation comprising:
a lower slab and a perimeter wall arranged on said lower slab, such that said foundation acts as a supporting base of the wind-powered generator on the seabed, and wherein the inner enclosure demarcated by the lower slab and the perimeter wall forms a main cavity that is open at the top, with said foundation being adapted for the intake of ballast material, and wherein in the absence of said ballast material, the wind-powered generator or its foundation is a floating or self-floating structure,
wherein the method comprises:
building the foundation in dry condition;
putting said foundation afloat;
transporting said foundation, in a floating or self-floating manner, to the vicinity of a pier;
depositing ballast material in the main cavity of the foundation,
increasing the depth of the foundation until it is supported in supporting terrain on the seabed, in a mounting position in the vicinity of said pier wherein, when the foundation is supported on said terrain, the upper level of the perimeter wall remains above the water level, without the water overflowing at the top from outside the foundation into its main cavity;
mounting on the foundation at least part of the shaft of the tower and the wind-powered generator, using for that purpose a crane arranged on the pier;
while the foundation remains supported in the mounting position on the supporting terrain, coupling the foundation to an auxiliary floating system, such that said foundation and said auxiliary floating system become integral with one another at least in terms of heave, roll, and pitch, the assembly of said foundation and said auxiliary floating system forming a transport unit, wherein the auxiliary floating system comprises:
vertical connection means adapted for vertically connecting the foundation and the auxiliary floating system and allowing vertical forces to be transmitted between both; and
upward movement/downward movement means adapted for adjusting in a controlled manner the vertical level or position of the foundation;
applying, through the upward movement/downward movement means, an upward vertical force on said foundation and a downward vertical force on said auxiliary floating system, such that at least part of the weight of the foundation and/or the wind-powered generator is suspended from said auxiliary floating system;
removing ballast material from the main cavity of the foundation;
putting the transport unit afloat;
transporting the transport unit in a floating or self-floating manner until being positioned over a final installation point on the seabed;
supporting the foundation on the seabed, on the final installation point, performing for that purpose the following steps in any order or simultaneously:
depositing ballast material in the main cavity of the foundation; and
acting on the upward movement/downward movement means so as to reduce in a controlled manner the height or level of the foundation, until it is supported on the seabed at the installation point, maintaining at all times a positive freeboard of the auxiliary floating system;
uncoupling the auxiliary floating system from the foundation, performing for that purpose one or more of the following steps:
acting on the upward movement/downward movement means to reduce and/or cancel out the vertical forces supported by the vertical connection means; and
disconnecting the vertical connection means from the foundation; and
transporting the auxiliary floating system for recovery and/or reuse.

2. The method according to claim 1, wherein the foundation of the wind-powered generator comprises one or more of the following elements:
a lower pedestal for supporting the tower shaft;
one or more separating partitions arranged inside the main cavity of the foundation; and
a plurality of supporting struts or props for supporting the tower shaft, or connected to a pedestal of the foundation itself and/or to the perimeter wall and/or to separating partitions arranged inside the main cavity of the foundation.

3. The method according to claim 1, wherein:
the lower slab and/or the perimeter wall are leak-tight, or
the lower slab and/or the perimeter wall comprise auxiliary intake points for taking in ballast material, optionally equipped with filling valves.

4. The method according to claim 1, wherein when acting on the upward movement/downward movement means so as to reduce in a controlled manner the height or level of the foundation, until it is supported on the seabed at the installation point, the water level surpasses the upper level of the perimeter wall with at least half of the volume of the main cavity of the foundation occupied by ballast material deposited when depositing ballast material in the main cavity of the foundation.

5. The method according to claim 1, wherein when depositing ballast material in the main cavity of the foundation, the entry of ballast material into the main cavity of the foundation is allowed through one or more auxiliary intake points for taking in said ballast material arranged in the lower slab and/or in the perimeter wall until the ballast material occupies at least half of the volume of the main cavity of the foundation.

6. The method according to claim 1, wherein when acting on the upward movement/downward movement means so as to reduce in a controlled manner the height or level of the foundation, until it is supported on the seabed at the installation point, the auxiliary floating system supports the weight of the foundation with a positive freeboard, with the main cavity of the foundation being completely filled with ballast material.

7. The method according to claim 1, wherein in the transport unit, the auxiliary floating system presents a freeboard greater than the freeboard of the perimeter wall of the foundation.

8. The method according to claim 1, further comprising one or more of:
filling at least part of the main cavity of the foundation with solid ballast material, provided through the upper opening of said foundation; and
protecting any of the elements of the wind-powered generator with one or more anti-washout means.

9. The method according to claim 1, further comprising:
assembling the foundation in a dry dock area, wherein said dry dock area presents a water intake sluice gate configured for adjusting the degree of flooding of the dry dock
when putting said foundation afloat, opening said sluice gate to flood the dry dock area, keeping the upper level of the perimeter wall of the foundation above the water level, such that the water does not flow over the top from outside the foundation into its main cavity; and/or
performing one or more start-up and/or performance monitoring operations of the wind-powered generator.

10. The method according to claim 1, wherein the filling of the main cavity of the foundation with ballast material is performed with water and/or by gravity.

11. The method according to claim 1, wherein the foundation comprises one or more side protrusions and a pre-stressing system adapted for applying a pre-stressing force for pressing the auxiliary floating system against said side protrusions of the foundation.

12. The method according to claim 1, wherein the upward movement/downward movement means comprise:
at least three lifting cranes or jacks arranged in the auxiliary floating system, comprising suspension cables the lower end of which are connected to the foundation,
wherein when acting on the upward movement/downward movement means so as to reduce in a controlled manner the height or level of the foundation, until it is supported on the seabed at the installation point, the foundation moves downwards by adjusting the length of said suspension cables, such that the relative level between the foundation and the auxiliary floating system varies as the foundation progressively moves downwards until reaching the bottom; and
adjustable floating means, adapted for modifying the degree of sinking of the foundation and/or of the transport unit.

13. The method according to claim 1, wherein when acting on the upward movement/downward movement means so as to reduce in a controlled manner the height or level of the foundation, until it is supported on the seabed at the installation point, the auxiliary floating system remains in substantially the same position with respect to the water level.

14. The method according to claim 1, wherein the final installation point on the seabed presents a depth of less than 15 m.

15. The method according to claim 1, wherein the upward movement/downward movement means comprise:
a fixed connection between the auxiliary floating system and the foundation which does not allow the relative level between both elements to vary; and
a ballast system in the auxiliary floating system (17) which allows the ballast (7) to be adjusted in the hull thereof,
wherein when acting on the upward movement/downward movement means so as to reduce in a controlled manner the height or level of the foundation, until it is supported on the seabed at the installation point, the foundation moves downwards by adjusting the ballast in the auxiliary floating system in order to increase the depth of the assembly, such that the floating system and the foundation move downwards together without varying their relative level until the foundation is supported on the bottom;
and wherein the auxiliary floating system has a height sufficient for being able to be immersed together with the foundation, maintaining at all times a positive freeboard.

16. The method according to claim 1, wherein the auxiliary floating system presents a ring structure which completely surrounds the foundation and is articulated so that it can open and close so as to be coupled to and uncoupled from said foundation.

17. The method according to claim 1, wherein the auxiliary floating system presents a water plane area and a freeboard such that when acting on the upward movement/downward movement means so as to reduce in a controlled manner the height or level of the foundation, until it is supported on the seabed at the installation point, the auxiliary floating system can support the weight of the wind-powered generator and the foundation partially immersed and with the main cavity completely filled with ballast, maintaining a positive freeboard.

18. A wind-powered generator installed according to the method of claim 1.
